(19) United States
(12) Patent Application Publication
(10) Pub. No.: US 2015/0088649 A1
(43) Pub. Date: Mar. 26, 2015

(54) Quick Audience Search and Recommendation Apparatus and Method

(71) Applicant: Acxiom Corporation, Little Rock, AR (US)

(72) Inventor: Joshua Herman, Potomac, MD (US)

(73) Assignee: Acxiom Corporation, Little Rock, AR (US)

(21) Appl. No.: 14/082,751

(22) Filed: Nov. 18, 2013

Related U.S. Application Data
(60) Provisional application No. 61/880,933, filed on Sep. 22, 2013.

(51) Int. Cl. G06Q 30/02

(52) U.S. Cl. CPC G06Q 30/0256
USPC 705/14.54

(57) ABSTRACT

A system and method for facilitating searching and recommendation for reaching a particular consumer audience with a marketing message operates across multiple media channels. Syndicated survey data for consumer behaviors is combined with consumer segmentation schema to create a subset of segments best associated with the product or service that is the subject of the marketing message. An average propensity index is calculated for that subset of best segments, and displayed for a user along with the total number of consumers in that subset of segments across multiple possible media channels.

### CROSS-REFERENCE TO RELATED APPLICATIONS

This application claims the benefit of provisional patent application no. 61/880,933, filed on Sep. 22, 2013, and entitled “Quick Audience Search and Recommendation Apparatus and Method.” Such application is incorporated by reference as if fully set forth herein.

### STATEMENT REGARDING FEDERALLY SPONSORED RESEARCH OR DEVELOPMENT

Not applicable.

### BACKGROUND OF THE INVENTION

The present invention relates to systems and methods for delivering a marketing message to consumers, and specifically to systems and methods for recommending an audience for a marketing message based on the product or service to be marketed across multiple media channels.

Targeted marketing is the effort to deliver a marketing message to those consumers who are most likely to be interested in the product or service that is being marketed. Targeted marketing is more efficient for the marketer since it increases the marketer's return on marketing and advertising expenditures. Targeted marketing also benefits the consumer, since the consumer is less likely to be presented with marketing messages in which the consumer is not interested and more likely to see marketing messages for products and services that appeal to the consumer. Identifying the correct consumers and correct marketing channels for a particular marketing message, however, may be a difficult task. Companies who market products and services to consumers and their advertising media agencies are in continuous cycles of looking for the characteristics of consumers who are most likely to purchase their products or services, and seeking to determine which marketing and media channels will deliver their marketing messages to those consumers with the characteristics most likely to make a purchase. Likewise, media sellers need to demonstrate that the audience they can deliver to the advertiser and their advertising media agency include a sufficient quantity of consumers with the characteristics mostly likely to buy products or services from the advertiser.

For these reasons, while the benefits of targeted marketing are well known, the selection of a particular audience for a marketing message remains a complex task for both large and small companies. This is particularly true when the marketer desires to deliver a marketing message through multiple media channels, such as direct mail, email, online, mobile publisher, and/or TV/video subscribers. Historically, this activity requires several multi-step processes to compile the necessary information, and has never before been brought together in an automated form. This problem has a dramatic, negative effect on the speed, cost, and accuracy of delivery of marketing messages that marketers, advertisers, media agencies, and media sellers experience when trying to plan marketing budgets and articulate the possible reach and propensity-to-purchase of a consumer audience across multiple marketing and media channels. Prior approaches to this problem have, for example, used nested selections of demographic or consumer behavior descriptions in software applications or drop-down boxes. This requires the user to know ahead of time which characteristics are included in the population with the highest propensity to make a purchase, to know which characteristics exist in the targeting capabilities across multiple marketing and media channels, and to hunt for combinations of data that have sufficient volume of consumers matched to those characteristics. The prior approaches to this problem can, as a result, take weeks or months to compile. A more simple, automated system and method to perform this functionality is thus highly desirable.

### BRIEF SUMMARY OF THE INVENTION

The invention is directed to an apparatus and method that enables consumer behaviors to be searched, whereby the search results yield the audience characteristics that are most likely to make a purchase, quantifies the audience's propensity for the searched-for behavior, and tabulates the number of households or individuals that have those top propensity characteristics across offline and digital media channels in various embodiments possibly including but not limited to direct mail, email, online display advertising, mobile advertising, and digital TV advertising. The invention leverages custom Internet application software and consumer database record matching technology to enable, in certain embodiments, natural language searching to yield search results that display the characteristics of the high-propensity audience population and the tabulated reach counts of households or individuals to various lists such as but not limited to direct mail lists, email marketing lists, online and mobile publisher user lists, and TV/video subscriber lists. In the preferred embodiment the invention is accessible by a website, and thus may be employed by users who are, for example, digital media planners, multichannel marketing planners, media salespeople, and media operations teams for publishers and advertising technology platform providers.

In one aspect, the invention is directed to a computer-implemented method for recommending an audience for a product marketing communication. A consumer behavior survey is received at a server system with a plurality of consumer survey response records each comprising a set of consumer behaviors. A consumer segment value is assigned to each of the plurality of consumer survey response records. A count for each consumer segment value across is tabulated, and an index propensity for each consumer segment value across is calculated, identifying for each consumer behavior a subset of consumer segment values that have the highest index propensities for that consumer behavior. The consumer behaviors are matched to the subset of consumer segment values. The server system receives from a client computing device connected to the server system over an electronic network a consumer behavior search request, and the server system sends to the client computing device, in response to the consumer behavior search request, a plurality of matching consumer behaviors and the matched subset of consumer segment values for each of the plurality of matching consumer behaviors.

In another aspect, the invention is directed to a computer-implemented method for recommending an audience for a product marketing communication. An index table comprising a plurality of consumer behaviors and a matched set of consumer counts for each of a set of consumer segment values across each of the plurality of consumer behaviors is constructed. An audience recommendation table is then constructed, which includes a plurality of consumer behaviors and, for each of the plurality of consumer behaviors, a subset of the set of consumer counts that have the highest propensity index for each such consumer behavior. The index table, audience recommendation table, and media channel table are stored at a digital storage medium in communication with the server. A consumer behavior search term is received at the server from the remote computing device, and then the audience recommendation table is searched for consumer behaviors that match the consumer behavior search term. All matched consumer behaviors are identified together with the subset of the set of consumer counts that have the highest propensity index for each such matched consumer behavior. A plurality of matching consumer behaviors are sent from the server to the client computing device in response to the consumer behavior search term.

In still another aspect, the invention is directed to a computer system for recommending an audience for a product marketing communication. The computer system includes an audience recommendation table stored on a digital storage medium, which includes a plurality of consumer behaviors, and for each of the plurality of consumer behaviors a subset of a set of consumer counts, wherein the subset of the set of consumer counts comprise those counts that have the highest propensity index for each such consumer behavior. The computer system also includes a media channel table stored on the digital storage medium that, for each consumer segment value in the set of consumer segment values, comprises a consumer record count for each of a plurality of media channels. There is also an audience search routine configured to receive as input an audience search term, search the audience recommendation table for consumer behaviors that match the audience search term, and return all matched consumer behaviors together with the subset of the set of consumer counts that have the highest propensity index for each such matched consumer behavior. A channel match routine is configured to search the media channel table for each consumer segment value in the subset of the set of consumer counts for each matched consumer behavior returned by the audience search routine, and return the consumer record count for each of the plurality of media channels associated with that consumer segment value. A display routine is configured to receive from the audience search routine and display on a computer display the matched consumer behaviors, subset of the consumer counts that have the highest propensity index for each such matched consumer behavior and average propensity index for the subset of the set of consumer counts that have the highest propensity index for each such matched consumer behavior. The display routine is further configured to receive from the channel match routine and display, for each of the consumer counts that have the highest propensity index for each such matched consumer behavior, the consumer record count for each of the plurality of media channels associated with the consumer segment value.

These and other features of the present invention will become better understood from a consideration of the following detailed description of the preferred embodiments and appended claims in conjunction with the drawings as described following:

### BRIEF DESCRIPTION OF THE SEVERAL VIEWS OF THE DRAWINGS

FIG. 1 is an illustration of a display result for a natural language search of consumer behaviors expanded to include demographic descriptors and reach counts according to a preferred embodiment of the present invention.

FIG. 2 is an illustration depicting a portion of an index table according to a preferred embodiment of the present invention.

FIG. 3 is an illustration depicting an audience recommendation table according to a preferred embodiment of the present invention.

FIG. 4 is an illustration depicting a matching of consumer segments to marketing lists for particular media channels according to a preferred embodiment of the present invention.

FIG. 5 is an illustration of a search function result performed according to a preferred embodiment of the present invention without including demographic descriptors and reach counts.

FIG. 6 is an illustrating of a profile population table for calculating propensity indexes for segments.

FIG. 7 is a flow chart depicting a method according to a preferred embodiment of the present invention.

FIG. 8 is an illustration depicting a network for operation of a preferred embodiment of the present invention.

FIG. 9 is an illustration of

### DETAILED DESCRIPTION OF THE PREFERRED EMBODIMENT(S)

Before the present invention is described in further detail, it should be understood that the invention is not limited to the particular embodiments described herein, and that the terms used in describing the particular embodiments are for the purpose of describing those particular embodiments only, and are not intended to be limiting, since the scope of the present invention will be limited only by the claims.

The preferred embodiment of the present invention threads together five foundational components in order to improve the inefficiency previously endured trying to find an audience definition and size across multiple media channels. The five components include 1) natural language search; 2) syndicated survey data for thousands of consumer behaviors; 3) syndicated consumer segmentation schema; 4) propensity calculations; 5) and consumer list file matching. Using the preferred embodiment, the user can type in a natural language search term that will return results showing all of the consumer behavior survey response descriptions that matched the search term, the primary demographic characteristics of households with the highest propensity to engage in the consumer behavior described in the survey data, the calculated propensity index for those households described, and the number of households that match to those high-propensity characteristics across multiple marketing lists across multiple media channels including social media, mobile, online, email, direct mail, and TV.

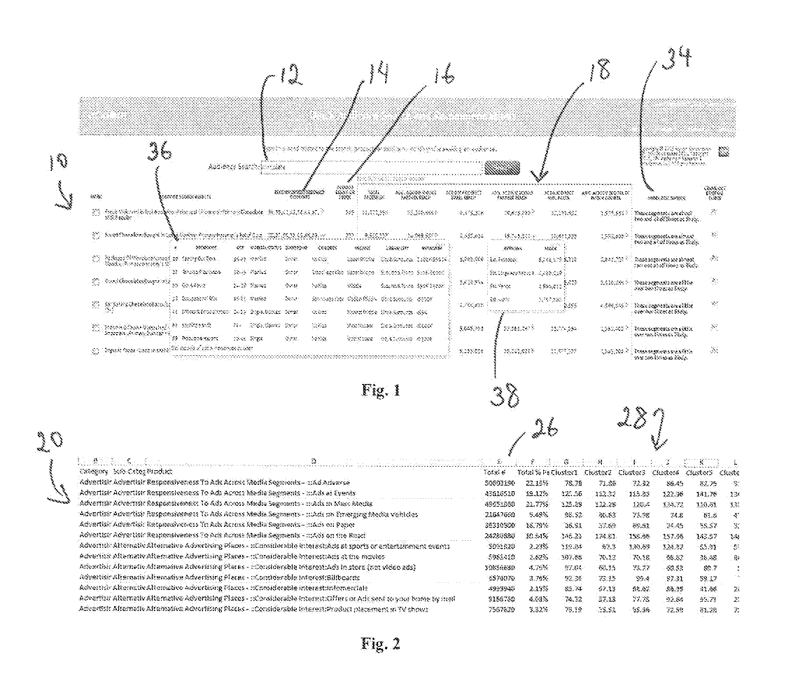

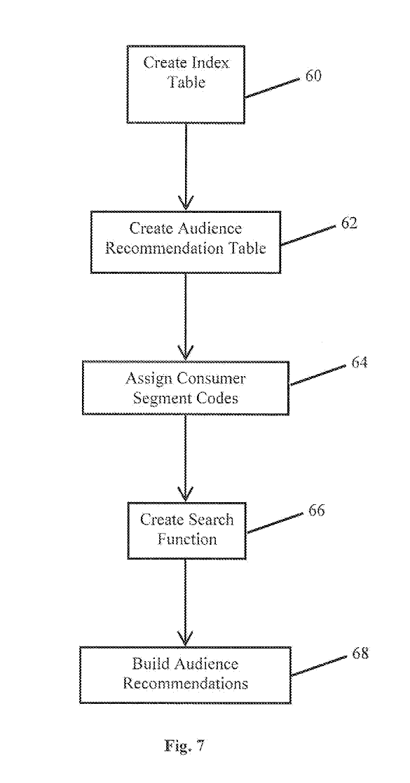

FIG. 1 depicts a partial image of the results when searching on the word ‘chocolate’, which is entered at text box 12. In response to entering the word, a search is performed whereby the multiple consumer behavior survey questions 10 matching the word ‘chocolate’ are presented, along with the recommended consumer segments 14; their characteristics and average propensity index 16; and the quantity of consumers whose characteristics match to the recommended segments and are found on marketing and advertising lists by online publishers, mobile publishers, direct mail lists, email lists, and TV subscriber lists 18. The preferred embodiment allows the user to perform natural language search against a taxonomy of thousands of consumer behaviors; recommend which segments should be targeted for marketing messages and offers according to their propensity to engage in the searched for behavior; and show the current number of consumers who match those recommended segment characteristics. Components of the preferred embodiment include consumer behavior population survey samples, a method of segmenting the consumer population, and a method of tabulating the segments of the consumer population against a list of consumers that are reachable across different media channels such as online, mobile, direct mail, email, and TV/video consumer user lists. The method of building the view shown in FIG. 1 can now be described in the following steps, in conjunction with the flow chart of FIGS. 7 and 9.

In the preferred embodiment, a prerequisite for the calculations and other steps described herein is a multi-sourced consumer demographic compilation database 90, as shown in FIG. 9. Such a database contains demographic information about a large population of consumers or households, such as consumers within the United States. An example of such a database 90 is the Infobase database maintained by Acxiom Corporation. Such database 90 may be coded with a consumer database link in order to uniquely identify data pertaining to particular consumers, households, and the like. The technology for providing this linking may, for example, be as described in U.S. Pat. Nos. 6,073,140, 6,523,041, or 6,766,327.

Referring again to FIG. 9, database 90 is used to build a segmentation database for digital media 92 and a segmentation database for direct mail and email marketing 94. In each of the segmentation databases 92 and 94, a consumer segment value is assigned to the respondents of a survey of consumer behavior. This assignment is performed by finding a match between a combination of personally identifiable information (PII) available on the survey responses and such information available in database 90. Such information used for matching may include, for example, name, address, email address, telephone number, and TV set top box address. In the preferred embodiment, the Personicx consumer segmentation system developed by Acxiom Corporation is employed for the purpose of segmentation. The Personicx segmentation system assigns a value from 1-70 to all consumers/households based on purchasing behaviors. Using the assignment of Personicx segment codes, data sets 96 are created that will be used in further processing as described below.

Once these data sets are made available, the first step of the method according to a preferred embodiment is to create an index table of consumer behavior survey responses to the pre-defined consumer segmentation schema at block 60 of FIG. 7. Using consumer survey data, a consumer segment value is assigned to the respondents of the consumer behavior surveys. The preferred embodiment uses a large survey of consumer behavior, generated using data for the survey responders and their respective responses to thousands of survey questions. Each of these values corresponds to consumers with particular purchasing behaviors. The responses to the survey questions are tabulated across the consumer segments. The tabulated counts for each consumer segment across each consumer behavior survey question response is then created. These tabulated counts are then compared to the national counts of the segmentation schema (in the case of the preferred embodiment, the Personicx segmentation system) so that an index propensity is calculated for each segment across each consumer behavior. This table is used to create the sub-table of recommended audience segments in the preferred embodiment. FIG. 2 depicts the resulting index table with consumer survey response descriptions 20, the total counts for each consumer survey response description 26, and columns for each of the counts in each of the Personicx clusters 28.

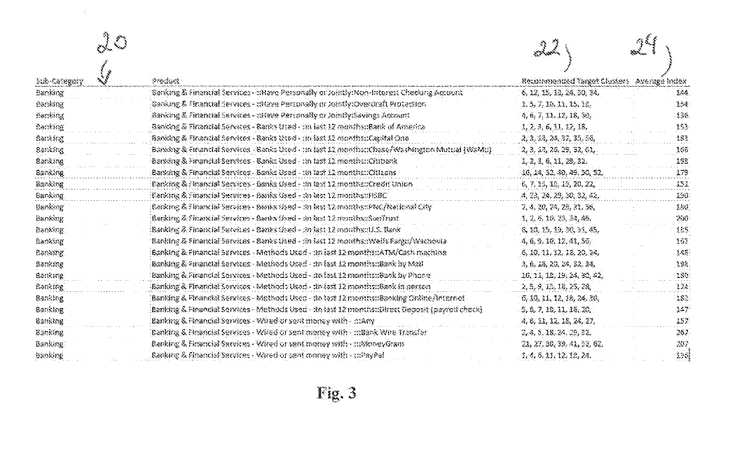

The next step is to create the audience recommendation table as depicted in FIG. 3, which is performed at block 62 of FIG. 7. A subset of consumer segments that are the top indexing segments for each of the consumer behaviors are identified and set aside into a separate table that also includes the propensity index for each cluster in that subset for each behavior. In the preferred embodiment, the top decile of the consumer segments for each behavior is placed in the top-performing subset. FIG. 3 shows a portion of the resulting audience recommendation table, containing the consumer survey response descriptions 20, recommended target clusters for each consumer survey response description 22, and average propensity index over the recommended target clusters 24.

The calculation of propensity indexes for the audience recommendation table of FIG. 3 may be described in more detail with reference to the table of FIG. 6. The table lists each consumer segment in conjunction with a base population (the population as known by the marketer for that segment) as well as the number of customers for a particular application, such as a consumer survey responder population. It may be seen, for example, in the table of FIG. 6 that for segment 65, nicknamed “Thrifty Elders,” there are 1,629,600 households in that segment from the overall marketer national database, which represents 1.60% of the households in the database. Likewise for this row in the table, it may be seen that there are 5,461 households in segment 65 from the consumer survey responder population, which represents 6.95% of the survey responder households. In order to calculate the propensity index for this segment in the survey responder households, the percentage of the survey responder households for this segment is divided by the percentage of total households in this segment, and the quotient multiplied by 100. For this row of the table, the result is a propensity index of 434.2, which means that for this survey question the respondents to the consumer survey are 434.2% more likely to respond positively than those persons in this segment in the overall population. The process may be repeated for thousands of consumer behaviors tabulated to the consumer survey data in order to create the audience recommendation table of FIG. 3. The top decile of segments based on propensity index may also be calculated. In this particular example, it may be seen that the top seven segments correspond to the top 10% (decile) of the survey population for this particular consumer survey response.

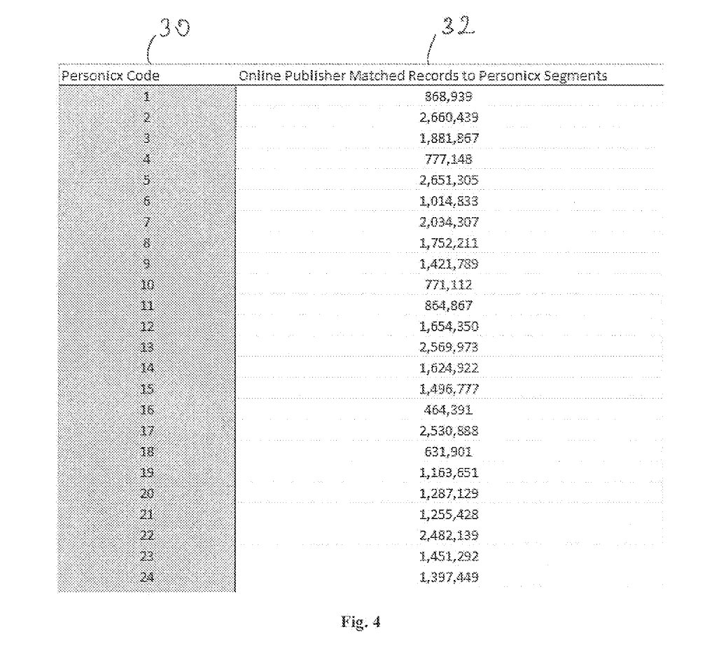

In the next step, at block 64 of FIG. 7, consumer segment codes 30 are assigned to different permissible marketing lists across different media channels, resulting in the table of FIG. 4. The consumer segmentation codes used as the recommended audience segments in the preferred embodiment must also be accurately associated to marketing lists across different media channels such as online, mobile, email, direct mail, and TV/video. The segmentation codes 30 on these lists are tabulated and aggregated to reflect the possible reach/size of the recommended audience in the tool. In the example of FIG. 4, a Personicx code is matched to the number of consumers in each segment who use an online publisher's services 32. The same matching is performed for each marketing channel.

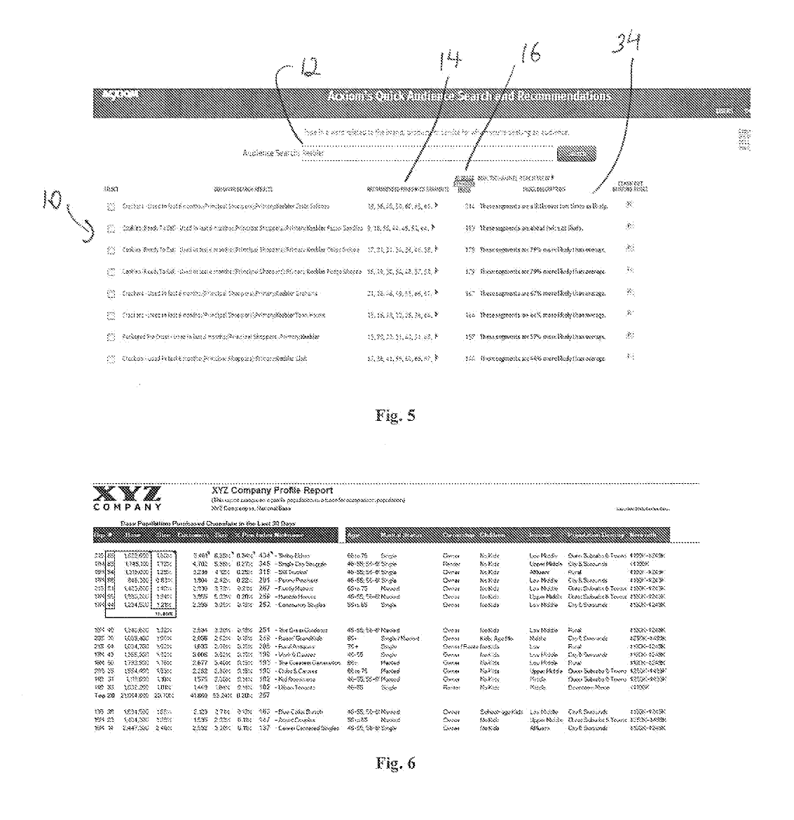

In the next step at block 66 of FIG. 7, a search function is created in order to find the best consumer behaviors and audience recommendations for a particular marketing message. In the preferred embodiment, a natural language software search function is used to allow the user to type in a word or phrase of a consumer behavior, brand, or service into a data entry box 12 which returns those consumer behavior descriptions that match the searched-for criteria. FIG. 5 depicts the results of searching on the term ‘keebler’ at text entry box 12 and the results of matching that term to all of the consumer behavior survey descriptions in a database of over 11,000 different consumer behavior survey descriptions. (The view of FIG. 5 is generally similar to that of FIG. 1, except that in this case the view is not expanded to include additional demographic descriptors or reach counts.) The top matching consumer descriptions 10 are returned, along with associated data as further described below.

In the final step, at block 68 of FIG. 7, the system connects the searched-for term with the audience recommendation segments and their reach across media channels, using the consumer segment code as the common key in the tables of FIGS. 3 and 4 in order to link this data. Those consumer behavior descriptions that match the searched-for criteria are displayed along with the target audience recommendation comprised of the consumer segments found in the top indexing decile (using the table of FIG. 3) for those searched-for behaviors along with the tabulated counts of those recommended segments for the different marketing lists scored with the segment values used for the audience recommendation (from the table of FIG. 4). The result for the user is a display of information as shown in FIG. 1. The consumer survey response fields 10 that match the search term are displayed, in conjunction with the recommended consumer segments 14, average propensity index 16, total number of consumers reached in each of various marketing channels 18, together with a textual description of the strength of the connection between the search term and each of the consumer survey responses 34. Pop-up windows are preferably available to show additional information, such as additional information about Personicx clusters at window 36 and additional information about various aspects of a particular marketing channel at window 38.

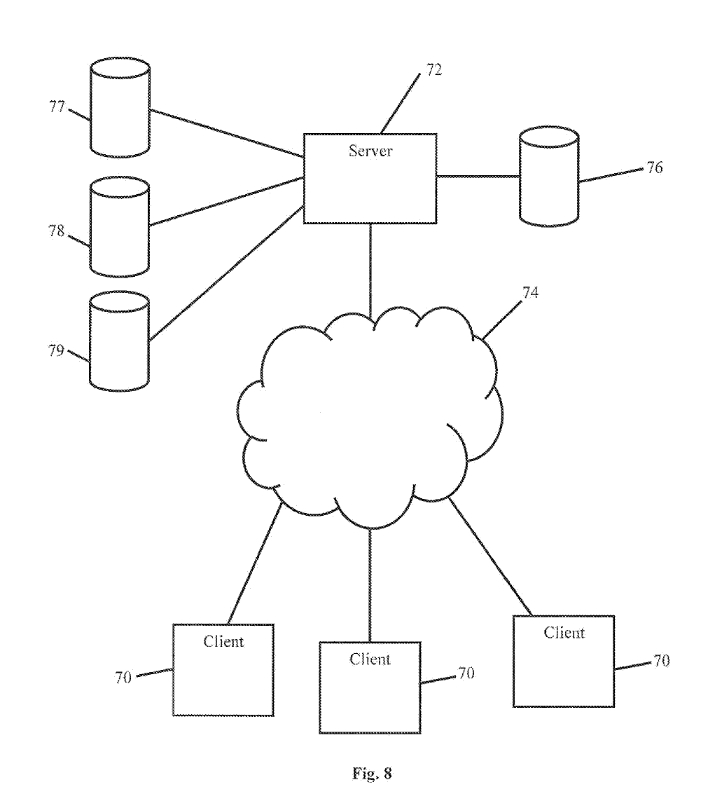

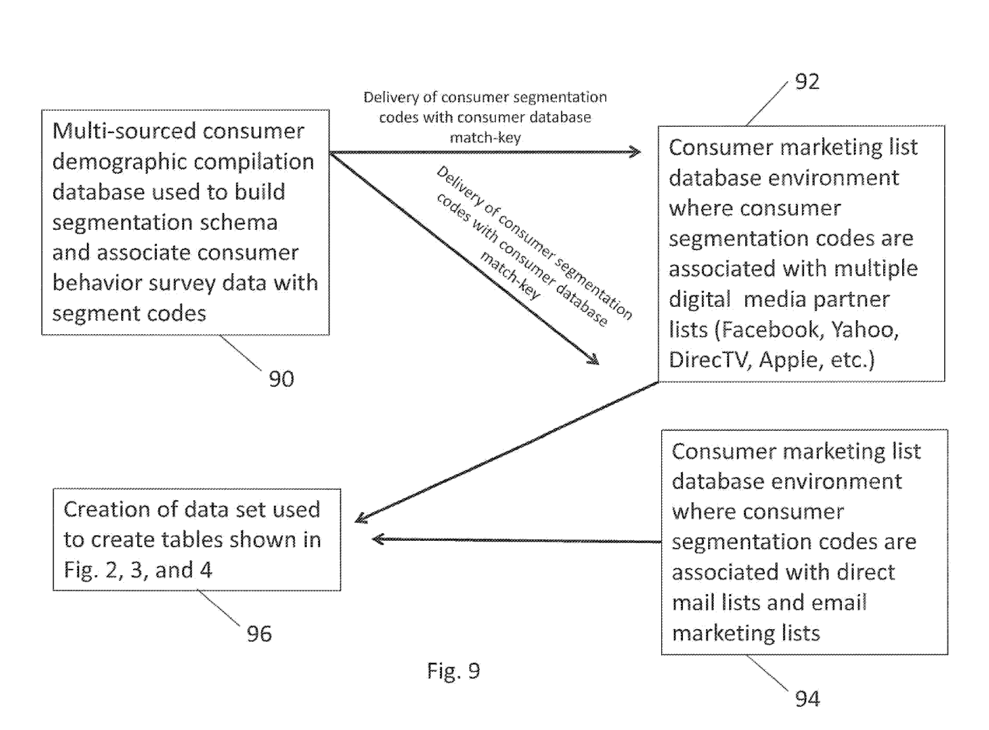

Each of the components of the system described may be preferably implemented as software executing on computer servers and client devices in conjunction with physical storage media in an electronic network as shown in FIG. 8. One or more client computing devices 70 are used to access the system by the party seeking the audience recommendation services for a marketing message. The client computing devices 70 communicate with a server 72 over a network 74, such as the Internet. The functionality of the search and related table building functions are performed on a microprocessor at server 72. Client 70 may access the software at server 72 in order to input the search terms and view results through a standard Internet browser. The preferred embodiment thus functions as a “software-as-a-service” (SaaS) solution, although other configurations are possible in alternative embodiments. The tables and other data described herein may be stored at storage media 76, which may include magnetic storage media and/or solid state storage media. Consumer demographic database 77, consumer segments applied to digital media database 78, and consumer segments applied to direct mail and email lists database 79 are also in communication with server 72. Although depicted in FIG. 8 as separate, any of databases 77, 78, and 79 may be implemented on any number of separate physical storage devices, stored in conjunction with each other, or stored partly or wholly in cloud-based storage such that they are physically remove from server 72 and/or accessible over network 74.

All of the electronic components are preferably constructed from digital electronic circuitry. The hardware components include servers and one or more clients as depicted in FIG. 8 that are physically apart from each other but interact via communication networks such as LAN (local area network), WAN (wide area network), or the Internet. The software components of the computer system include machine-readable instructions for a programmable processor written in low-level assembly language, or preferably high level procedural and/or object-oriented programming language. One or more executable computer programs are implemented on a programmable server system including at least one programmable processor, which may be special or preferably general purpose, and that can receive data and instructions from, and transmit data and instructions to, a storage system. This programmable server system includes at least one input device, and at least one output device, as does the client device in communication with the programmable server system.

Focusing more specifically on the software executing at server 72, a section of sample code for showing media counts across multiple media channels as depicted in FIG. 1 may be as follows:

function html_form_element($params=array( )){

foreach(self::$counts as $key => $config){

if(isset($config[‘sum’])){

$s.=$config[‘label’].‘<div style=“margin-left:20px”>’;

$s.=‘<input type=“checkbox”

name=“‘.$basename.’[‘.$key.’][_showdetails]”’;

$s.=(isset($v[$key][‘_showdetails’])?‘

checked=“checked” ‘:’’).’ value=“1” />’;

$s.=‘Show details in addition to total’

.‘<table class=“fieldPref”

><thead><tr><td></td><td>Included</td><td>Included &amp; show
count</td><td>Not Included<td></tr></thead><tbody>’;

foreach($config[‘sum’] as $sumkey => $sumconfig){

$s.=‘<tr><th>’.$sumconfig[‘label’].‘:</th>’;

$chk= (isset($v[$key][$sumkey]) &&

($v[$key][$sumkey]==‘N’ || $v[$key][$sumkey]==‘1’))?‘
checked=“checked”
‘:’’;

$s.=‘<td><input type=“radio”

name=“‘.$basename.’[‘.$key.’][‘.$sumkey.’]” value=“N” ‘.$chk.’
/></td>’;

$chk= (isset($v[$key][$sumkey])&&

$v[$key][$sumkey]==‘C’ )?‘ checked=“checked” ’:”;

$s.=‘<td><input type=“radio”

name=“‘.$basename.’[‘.$key.’][‘.$sumkey.’]” value=“C” ‘.$chk.’
/></td>’;

$chk= (!isset($v[$key][$sumkey]) ||

$v[$key][$sumkey]==”)?‘ checked=“checked” ’:’’;

$s.=‘<td><input type=“radio”

name=“‘.$basename.’[‘.$key.’][‘.$sumkey.’]” value=“” ‘.$chk.’
/></td>’;

$s.=‘’; ; }

$s.=‘</tr></tbody></table></div>’;

}else{ $chk= isset($v[$key])?‘ checked=“checked” ‘:’’;

$s.=‘<label><input type=“checkbox”

name=“‘.$basename.’[‘.$key.’]’.’” value=“1” ‘.$chk.’ />’

.(isset($config[‘label_html’])?$config[‘label_html’]:$config[‘label’])

.‘</label>’ ; } }

return $s; }

static function viewprefs_cleaner($viewpref){

$viewpref=is_array($viewpref)?$viewpref:array( );
foreach (array_keys($viewpref) as $key) {

if(isset(self::$counts[$key][‘sum’])){ $use=false;

foreach(self::$counts[$key][‘sum’] as $sumkey => $bool){

if(isset($viewpref[$key][$sumkey]) &&

$viewpref[$key][$sumkey]!=‘’){

$use=true; } }

if(!$use){

unset ($viewpref[$key]); } } }

return $viewpref; }

static function column_title($key){

return
isset(self::$counts[$key][‘label_html’])

?self::$counts[$key][‘label_html’]

:htmlspecialchars(aarfieldcountprefs::$counts[$key][‘label’]); }

Sample code for searching survey behavior taxonomy, and showing results from the high propensity index table, and the natural language phrase used to describe the index value for each propensity index value, may be as follows:

static function objects_for_search($s, $limit=0){
$sql=‘SELECT object_data FROM

’.BBXObjTool::obj_table(_{——}CLASS_{——})

.‘WHERE UPPER(product) LIKE UPPER(:s) ’ ;

if($limit>0){

$sql.=‘ LIMIT ’.intval($limit); }

$O=array( );

$bindings[‘s’]=‘%’.trim($s).’%’;

foreach(bbxSQLite::fetchfirstcolumn(BBXObjTool::db_handle(_{——}CL

ASS_{——}), $sql, $bindings) as $instance){

if($obj=bbxObjTool::recreate(_{——}CLASS_{——},$instance)){

$O[ ]=$obj; } }

return($O); }
public function index_description($show_period=true){
$str=‘These segments are ’;
$hundreds= floor($this−>average_index−>value/100);
$tens = $this−>average_index−>value%100;
switch (true) {
case $hundreds==1 && $tens<= 89:

$str.=$tens.‘% more likely than average’;

case $this−>average_index−>value>=190 && $this−

>average_index−>value<=210;
$str.=‘about twice as likely’;

case $tens<=10:

$str.=‘about ’.self::wordforint($hundreds).‘ times as likely’;

case $tens>=11 && $tens<=30:

$str.=‘a little over ’.self::wordforint($hundreds).‘ times as likely’;

case $tens>=31 && $tens<=45:

$str.=‘almost ’.self::wordforint($hundreds).‘ and a half times as likely’;

case $tens>=46 && $tens<=60:

$str.=‘about ’.self::wordforint($hundreds).‘ and a half times as likely’;

case $tens>=61 && $tens<=75:

$str.=‘a little over ’.self::wordforint($hundreds).‘ and a half times as likely’;

case $tens>=76 && $tens<=90:

$str.=‘almost ’.self::wordforint($hundreds+1).‘ times as likely’;

case $tens>=91:

$str.=‘about ’.self::wordforint($hundreds+1).‘ times as likely’;

```
  default:
  $str.=$hundreds.‘ ’.$tens; }
return $str.($show_period ? ‘.’ : ‘’); }
```

static function wordforint($i){ );

if(isset($W[$i])){

return $W[$i]; }

return $i; }

public function get_clusters( ){

$A=array( );
foreach(explode(‘,’,$this−>recommended_target_clusters−

>value) as $code){

$code=intval($code);
if($code>0){

$A[ ]=aarCluster::get_obj_for_cluster_code($code); } }
return($A); } }

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. All references cited herein are hereby incorporated by reference to the extent that there is no inconsistency with the disclosure of this specification. When a range is expressed herein, all values within and subsets of that range are intended to be included in the disclosure.

The present invention has been described with reference to certain preferred and alternative embodiments that are intended to be exemplary only and not limiting to the full scope of the present invention as set forth in the appended claims.

1. A computer-implemented method for recommending an audience for a marketing message, the method comprising the steps of:
a. receiving at a server system a consumer behavior survey comprising a plurality of consumer survey response records each comprising a set of consumer behaviors;
b. assigning a consumer segment value from a set of consumer segment values to each of the plurality of consumer survey response records;
c. tabulating a count for each consumer segment value across the set of consumer behaviors;
d. calculating an index propensity for each consumer segment value across the set of consumer behaviors;
e. identifying for each consumer behavior a subset of consumer segment values that have the highest index propensities for that consumer behavior;
f. matching each of the consumer behaviors to the subset of consumer segment values;
g. receiving at the server system from a client computing device connected to the server system over an electronic network a consumer behavior search request; and
h. sending to the client computing device, in response to the consumer behavior search request, a plurality of matching consumer behaviors and the matched subset of consumer segment values for each of the plurality of matching consumer behaviors.

2. The computer-implemented method of claim 1, further comprising the steps of calculating an average propensity index for each of the subset of consumer segment values matched to each of the set of consumer behaviors and sending to the client computing device, in response to the consumer behavior search request, the average propensity index for each of the subset of consumer segment values matched to each of the set of consumer behaviors.

3. The computer-implemented method of claim 2, further comprising the steps of matching to each consumer segment value in the set of consumer segment values a number of reachable audience members in that consumer segment value for each of a plurality of media channels and sending to the client computing device, in response to the consumer behavior search request, the number of reachable audience members for each of the plurality of media channels for each consumer segment value in the set of consumer segment values.

4. The computer-implemented method of claim 3, wherein the consumer behavior search request comprises a natural language search term.

5. The computer-implemented method of claim 4, further comprising the step of associating with each of the plurality of matching consumer behaviors sent to the client computing device in response to the consumer behavior search request a textual description of the strength of the connection between the search term and each of the consumer survey responses.

6. A computer-implemented method for recommending an audience for a marketing message, the method steps comprising:
a. constructing an index table comprising a plurality of consumer behaviors and a matched set of consumer counts for each of a set of consumer segment values across each of the plurality of consumer behaviors;
b. constructing an audience recommendation table comprising the plurality of consumer behaviors, for each of the plurality of consumer behaviors a subset of the set of consumer counts that have the highest propensity index for each such consumer behavior;
c. storing the index table and audience recommendation table at a digital storage medium in communication with a server comprising a processor, wherein the process is configured to send and receive communications over a network from a client computing device;
d. receiving at the processor a consumer behavior search term from the remote computing device;
e. searching the audience recommendation table for consumer behaviors that match the consumer behavior search term, and identifying all matched consumer behaviors together with the subset of the set of consumer counts that have the highest propensity index for each such matched consumer behavior; and
f. sending from the processor to the client computing device, in response to the consumer behavior search term, a plurality of matching consumer behaviors.

7. The computer-implemented method of claim 6, further comprising the steps of:
a. constructing a media channel table comprising, for each consumer segment value in the set of consumer segment values, a consumer record count for each of a plurality of media channels, and storing the media channel table at the digital storage medium;
b. searching the media channel table for each consumer segment value in the subset of the set of consumer counts for each matched consumer behavior returned by the search of the audience recommendation table, and identifying the consumer record count for each of the plurality of media channels associated with that consumer segment value; and
c. sending from the processor to the client computing device, in response to the consumer behavior search term, the number of reachable audience members for each of the plurality of media channels.

8. The computer-implemented method of claim 7, wherein the audience recommendation table further comprises, for each of the plurality of consumer behaviors, an average propensity index for the subset of the set of consumer counts that have the highest propensity index for each such consumer behavior, and wherein the method further comprises the step of sending from the processor to the client computing device, in response to the consumer behavior search term, the average propensity index for the matched subset of consumer segment values for each of the matching consumer behaviors.

9. The computer-implemented method of claim 8, further comprising the step of creating for each of the plurality of matching consumer behaviors sent to the client computing device in response to the consumer behavior search term a textual description of the strength of the connection between the search term and each of the consumer survey responses, and sending the textual description of the strength of the connection between the search term and each of the consumer survey responses to the client device.

10. The computer-implemented method of claim 9, wherein the consumer behavior search term comprises a natural language search term.

11. A computer system for recommending an audience for a product marketing communication, comprising:
a. an audience recommendation table stored on a digital storage medium, wherein the audience recommendation table comprises a plurality of consumer behaviors, for each of the plurality of consumer behaviors a subset of a set of consumer counts, wherein the subset of the set of consumer counts comprise those counts that have the highest propensity index for each such consumer behavior;
b. a media channel table stored on the digital storage medium that for each consumer segment value in the set of consumer segment values comprises a consumer record count for each of a plurality of media channels;
c. an audience search routine stored on the digital storage medium and executable on a computer processor in communication with the digital storage medium, wherein the search routine is configured to receive as input an audience search term, search the audience recommendation table for consumer behaviors that match the audience search term, and return all matched consumer behaviors together with the subset of the set of consumer counts that have the highest propensity index for each such matched consumer behavior;
d. a channel match routine stored on the digital storage medium and executable on the computer processor, wherein the channel match routine is configured to search the media channel table for each consumer segment value in the subset of the set of consumer counts for each matched consumer behavior returned by the audience search routine, and return the consumer record count for each of the plurality of media channels associated with that consumer segment value; and
e. a display routine stored on the digital storage medium and executable on the computer processor, wherein the display routine is configured to receive from the audience search routine and send to a client device the matched consumer behaviors, the subset of the consumer counts that have the highest propensity index for each such matched consumer behavior, and further configured to receive from the channel match routine and send to the client device, for each of the consumer counts that have the highest propensity index for each such matched consumer behavior, the consumer record count for each of the plurality of media channels associated with the consumer segment value.

12. The computer system of claim 11, further comprising an index table stored on a digital storage medium, wherein the index table comprises the plurality of consumer behaviors and a matched set of consumer counts for each of a set of consumer segment values across each of the plurality of consumer behaviors.

13. The computer system of claim 11, wherein the audience recommendation table further comprises for each of the plurality of consumer behaviors an average propensity index for the subset of the set of consumer counts that have the highest propensity index for each such consumer behavior.

14. The computer system of claim 13, wherein the audience search routine is further configured to return the average propensity index for the subset of the set of consumer counts that have the highest propensity index for each such matched consumer behavior.

15. The computer system of claim 14, wherein the display routine is further configured to, for each of the plurality of matching consumer behaviors sent to the client computing device in response to the consumer behavior search term, send a textual description of the strength of the connection between the search term and each of the consumer survey responses.
